(19) United States
(12) Patent Application Publication
(10) Pub. No.: US 2012/0113823 A1
(43) Pub. Date: May 10, 2012

(54) METHOD AND SYSTEM FOR VERY HIGH FREQUENCY DATA LINK CAPACITY ENHANCEMENT

(75) Inventors: Dongsong Zeng, Germantown, MD (US); E.F. Charles LaBerge, Towson, MD (US)

(73) Assignee: HONEYWELL INTERNATIONAL INC., Morristown, NJ (US)

(21) Appl. No.: 12/188,071

(22) Filed: Aug. 7, 2008

(51) Int. Cl. H04W 24/00; H04L 12/26

(52) U.S. Cl. 370/252

(57) ABSTRACT

A method to increase throughput over a very high frequency aeronautical network is provided. The method comprises simultaneously receiving at least two downlink signals at a plurality of ground antennas at an aeronautical ground station of the very high frequency aeronautical network, generating a channel-state-information matrix based on preambles, decomposing the simultaneously received at least two downlink signals into respective ones of the at least two downlink signals, and decoding each of the respective ones of the decomposed at least two downlink signals. The at least two downlink signals include respective preambles indicative of a channel state. Solutions to the channel-state-information matrix are generated by a mean-square-error algorithm to avoid singularities in the solutions. The decomposing of the simultaneously received at least two downlink signals is based on the generated channel-state-information matrix.

### BACKGROUND

Currently available very high frequency data link mode 2 (VDLM2) networks have point-to-multiple-point architectures. The VDLM2 aeronautical ground station semi-periodically broadcasts its aeronautical ground station identification frame (GSIF). All aircraft in the range of this aeronautical ground station “listen” to GSIF. After the uplink transmission from the ground station to the aircraft is complete, the aircraft access the media randomly in a p-persistent ALOHA style. When more than two aircraft transmit to the ground station at the same time, messages sometimes collide at the aeronautical ground station. Since the aeronautical ground station currently only has one ground antenna, the colliding messages are dropped and the communication channel is not efficiently utilized. As the number of aircraft flying in the sky increases, the demand for air-to-ground communication increases. Currently, very high frequency data links are the primary channels for transferring data messages between aircrafts and aeronautical ground stations. The aeronautical very high frequency (VHF) frequency band is limited and is unlikely to expand.

The very high frequency data links are used by military aircraft to send and receive safety critical data. Some safety critical data is required to identify if another vehicle in the airspace is friend or foe. Other safety critical data is required to provide the location of another vehicle including unmanned aerial vehicles. In some cases, very high frequency data links used by aircraft are required to send and receive navigation data.

### SUMMARY

The present application relates to a method to increase throughput over a very high frequency aeronautical network. The method, in one embodiment, includes simultaneously receiving at least two downlink signals at a plurality of ground antennas at an aeronautical ground station of the very high frequency aeronautical network, generating a channel-state-information matrix based on preambles, decomposing the simultaneously received at least two downlink signals into respective ones of the at least two downlink signals, and decoding each of the respective ones of the decomposed at least two downlink signals. The at least two downlink signals include respective preambles that are indicative of a channel state. Solutions to the channel-state-information matrix are generated by a mean-square-error algorithm to avoid singularities in the solutions. The decomposing of the simultaneously received at least two downlink signals is based on the generated channel-state-information matrix. In this manner, independent transmissions from separate and independent sources are resolved using multiple-input-multiple-output techniques at a receiver in the aeronautical ground station.

### DRAWINGS

FIG. 1 is a block diagram of one embodiment of a VHF aeronautical network having multiple ground antennas on the aeronautical ground station in accordance with the present invention.

FIG. 2 is a block diagram of one embodiment of a VHF aeronautical ground station in a VHF aeronautical network in accordance with the present invention.

FIG. 3 is a block diagram of one embodiment of a VHF aeronautical network including an aircraft having multiple aircraft antennas and an aeronautical ground station having multiple ground antennas in accordance with the present invention.

FIG. 4 is a flow diagram of one embodiment of a method to increase throughput of information over a VHF aeronautical network in accordance with the present invention.

FIG. 5 is a block diagram of one embodiment of a VHF aeronautical network in accordance with the present invention.

FIG. 6 is a flow diagram of one embodiment of a method to increase throughput of information over a VHF aeronautical network in accordance with the present invention.

In accordance with common practice, the various described features are not drawn to scale but are drawn to emphasize features relevant to the present invention. Like reference characters denote like elements throughout figures and text.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

There is a need to increase the communication capacity within the aeronautical VHF frequency band. This need is especially important when safety critical information is being transmitted. Methods to increase the throughput of communication channels in the VHF band are described herein. It is desirable for the very high frequency data links used by military and commercial aircraft to send and receive safety critical data and/or navigation data at a higher throughput than is currently available.

In a one embodiment, multiple ground antennas at the aeronautical ground station are only used to receive signals from aircraft. This embodiment increases the communication efficiency in the VHF band using a single-input-multiple-output (SIMO) configuration. In another embodiment, multiple ground antennas on aeronautical ground station are used to receive signals from aircraft and to transmit signals to aircraft. This embodiment increases the communication efficiency in the VHF band using a SIMO configuration. In yet another embodiment, multiple ground antennas on the aeronautical ground station and multiple aircraft antennas on the aircraft increase the communication efficiency in the VHF band. In the configurations described herein, channel capacity is increased without extra frequency bands by exploiting the propagation diversities.

In yet another embodiment, successive interference cancellation (SIC) is used to increase the communication efficiency in the VHF band. The SIC method potentially extracts multiple outputs from the collided signals received at a single receive ground antenna. This SIC method is based on the types of signals that collide.

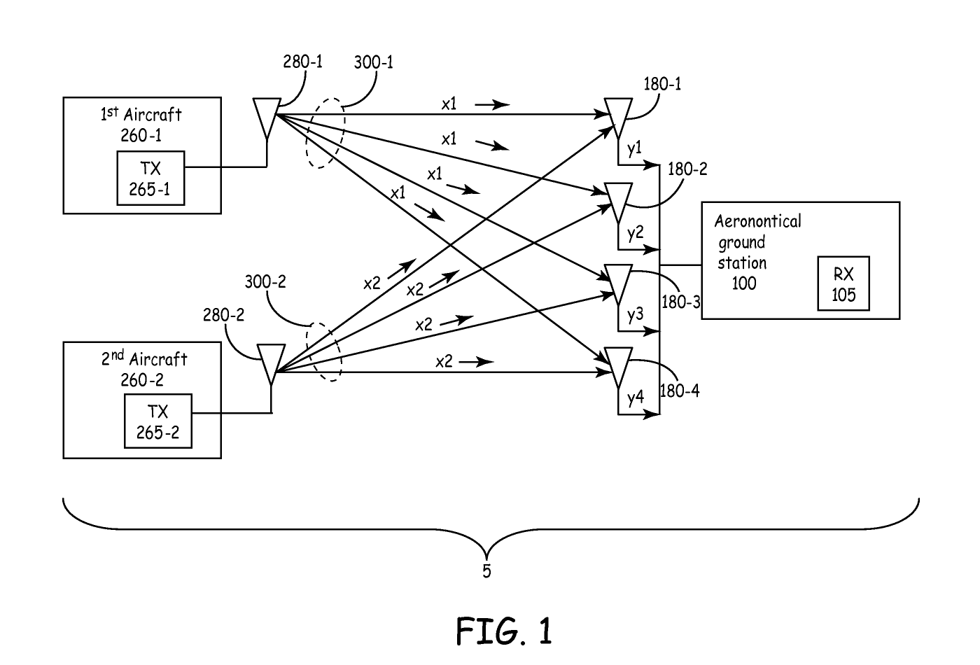

FIG. 1 is a block diagram of one embodiment of a VHF aeronautical network 5 having multiple ground antennas 180(1-4) on the aeronautical ground station 100 in accordance with the present invention. The VHF aeronautical network 5 includes a first aircraft 260-1, a second aircraft 260-2, and an aeronautical ground station 100. The first aircraft 260-1 and the second aircraft 260-2 are communicatively coupled to the plurality of ground antennas 180(1-4) at the aeronautical ground station 100. The first aircraft 260-1 and the second aircraft 260-2 include a transmitter 265-1 and a transmitter 265-2, respectively. The transmitters 265(1-2) are also referred to herein as “VDL radios 265(1-2).” The first aircraft 260-1 and the second aircraft 260-2 also include respective aircraft antennas 280(1-2).

The two aircraft antennas 280(1-2) transmit two respective downlink VHF signals represented generally by numerals 300-1 and 300-2 (alternatively represented generally as x₁ and x₂) at the same time (in the same time slot) and at the same carrier frequency (in the same radio frequency channel). The downlink VHF signals 300-1 and 300-2 include respective preambles indicative of a channel state. The preambles are in the message format and are used to synchronize channel information.

In one implementation of this embodiment, the transmitters 265(1-2) are transceivers. In another implementation of this embodiment, the VHF aeronautical network 5 has more than two aircraft. In yet another implementation of this embodiment, the downlink VHF signals 300-1 and 300-2 include safety critical signals. In yet another implementation of this embodiment, the downlink VHF signals 300-1 and 300-2 include navigation signals. In yet another implementation of this embodiment, the downlink VHF signals 300-1 and 300-2 include safety critical navigation signals.

The aeronautical ground station 100 includes a receiver 105 communicatively coupled to receive signals from the ground antennas 180(1-4). The receiver 105 is also referred to herein as a “VDL radio 105.” The two downlink VHF signals 300-1 and 300-2 are simultaneously received at the plurality of ground antennas 180(1-4). The simultaneously received signals are received at each of the four ground antennas 180(1-4) as a 2-channel spatially mixed signal. If N downlink VHF signals are received at the ground antennas 180(1-4), the simultaneously received signals are received at each of the four ground antennas 180(1-4) as an N-channel spatially mixed signal. Channel state information is known at the receiver 105 in the aeronautical ground station 100. The channel state information includes information for each radio path within the aeronautical ground station 100. In one implementation of this embodiment, the channel state information includes attenuation of the signal during propagation and phase-change of the signal during propagation. MIMO algorithms at the receiver 105 decompose the 2-channel spatially mixed signals into 2 clear channel signals by processing all four of the received 2-channel spatially mixed signals to generate a channel-state-information matrix based on the preambles. The receiver 105 then finds solutions to the channel-state-information matrix using a mean-square-error algorithm to avoid singularities in the solutions. The receiver 105 decodes the signals once the solutions to the channel-state-information matrix are determined.

The signals y₁, y₂, y₃, and y₄ received from the four ground antennas 180(1-4) are all mixed signals expressed as:

y₁=h₁₁x₁+h₁₂x₂

y₂=h₂₁x₁+h₂₂x₂ (1)

y₃=h₃₁x₁+h₃₂x₂

y₄=h₄₁x₁h₄₂x₂

For simplicity, the received noise is neglected throughout this document. The term hᵢⱼ includes the preamble information.

The receiver 105 in the aeronautical ground station 100 generates a channel-state-information matrix based on the preambles of the signals. Specifically, the receiver 105 estimates the channel-state-information matrix h through the preambles. Rewriting the above equations (1) leads to a simple vector equation (2), where h is the channel-state-information matrix:

y=hx. (2)

The simultaneously received downlink VHF signals y₁, y₂, y₃, and y₄ are decomposed into respective ones of the downlink VHF signals x₁, x₂ based on the generated channel-state-information matrix. The transmitted clear signals in the 2×1 matrix x are equal to the inverse matrix of h times y , i.e.,

x=h⁻¹y (3)

The receiver 105 uses the channel-state-information matrix to calculate the transmitted downlink VHF signals x₁, x₂. The solutions to the channel-state-information matrix are generated by a mean-square-error algorithm to avoid singularities in the solutions generated by directly inversing channel-state-information matrix h. The minimum mean squared error approach is used to recover the transmitted downlink VHF signals x₁, x₂ from the received signal y as:

$$\hat{x} = \sqrt{\frac{M}{{E}_{s}}} {( {h}^{*} h + \frac{{MN}_{0}}{{E}_{s}} I )}^{- 1} {h}^{*} y \qquad ( 4 )$$

where Eₛ is the symbol energy, h* is the conjugate transpose of matrix h, and N₀ is the noise density. The aeronautical ground station 100 decodes each of the respective ones of the decomposed at least two downlink VHF signals 300(1-2). For example, processors and/or decoders in the aeronautical ground station 100 are used decode the decomposed downlink VHF signals 300(1-2) received at the receiver 105. If three aircraft transmit three downlink VHF signals at the same time (in the same time slot) and at the same carrier frequency (in the same radio frequency channel) the four ground antennas 180(1-4) at the aeronautical ground station 100 each receives a 3-channel spatially mixed signal. In this case, the channel-state-information matrix h is a 4×3 matrix rather than the 4×2 matrix shown in equation (1).

This embodiment of the VHF aeronautical network 5 is a single-input-multiple-output (SIMO) system, since each aircraft 260(1-2) has only one respective aircraft antenna 280(1-2) while the receiver 105 in the aeronautical ground station 100 has multiple ground antennas 180(1-4). In the uplink, the aeronautical ground station 100 only transmits on one ground antenna, such as 180-1.

In the embodiment of VHF aeronautical network 5 shown in FIG. 1, the downlink data rate in SIMO is increased by a factor of four, since there are four ground antennas in the aeronautical ground station 100. In an implementation of the aeronautical network that includes an aeronautical ground station with M ground antennas, the downlink data rate in SIMO is increased by a factor of M.

The currently available VDL radios 265(1-2) in the first and second aircraft 260(1-2) do not require hardware changes in order to implement this method to increase the throughput of information, such as safety critical information, over a very high frequency data link. The aeronautical ground station 100 requires multiple ground antennas each associated with a respective radio frequency (RF) chain. The multiple RF chains and corresponding MIMO multi-channel decomposition algorithms for each RF chain.

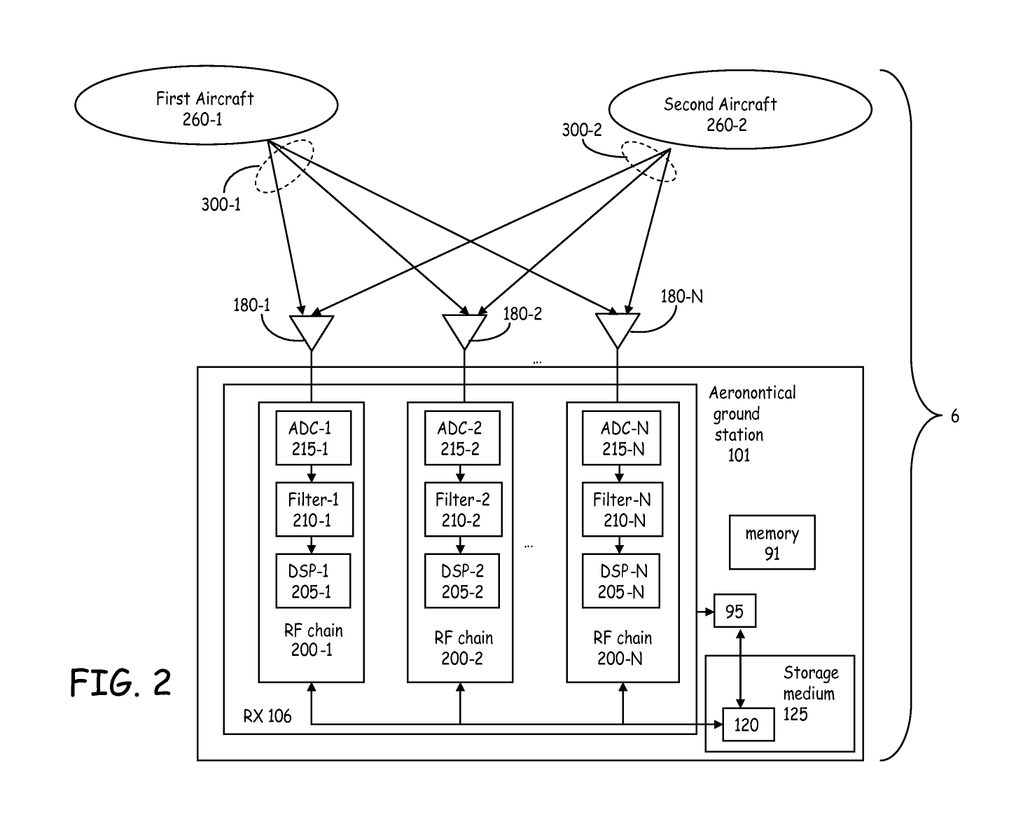

FIG. 2 is a block diagram of one embodiment of a VHF aeronautical ground station 101 in a VHF aeronautical network 6 in accordance with the present invention. The VHF aeronautical network 6 includes first aircraft 260-1 and the second aircraft 260-2 and the VHF aeronautical ground station 101. The aircraft antenna for the first aircraft 260-1 and the second aircraft 260-2 are not shown in FIG. 2. The aeronautical ground station 101 includes a plurality N of ground antennas 180(1−N), and a receiver 106 having a respective plurality of RF chains 200(1−N). The aeronautical ground station 101 also includes a memory 91, one or more processors 95, a storage medium 125, and computer instructions 120 to be executed by the one or more processors 95 and/or digital signal processors 205(1−N)) in the RF chains 200(1−N)). Channel state information is stored in the memory 91 in the aeronautical ground station 100. The channel state information includes information for each of the N radio paths within the aeronautical ground station 101. The receiver 106 is also referred to herein as a “VDL radio 106.”

Each RF chain 200(1−N)) includes an analog-to-digital converter (ADC) 215-i, a filter 210-i, and a digital signal processor 205-i, where “i” is representative of the i^{th} device of the N devices. The analog-to-digital converters 215(1−N)) receive signals from the coupled ground antennas 180(1−N)), respectively, and output converted signals to the respective filters 210(1−N)). The output from the filters 210(1−N)) is sent to the respective digital signal processors 205(1−N)) for processing. The output from the digital signal processors 205(1−N)) is sent to the one or more processors 95 for multiple-input-multiple-output (MIMO) decomposition.

Since two downlink VHF signals 300-1 and 300-2 are simultaneously received at the plurality of ground antennas 180(1−N)), each of the N ground antennas 180(1−N)) receives a 2-channel spatially mixed signal, which is processed by the associated RF chain 200(1-4). The one or more processors 95 receive output from the RF chains 200(1-4) and execute computer instructions 120 (for example, MIMO multi-channel decomposition algorithms) to decompose the four 2-channel spatially mixed signals received from the RF chains 200(1-4) into 2 clear channel signals that are equivalent to the signals 300(1-2).

Specifically, the one or more processors 95 process all N of the received 2-channel spatially mixed signals to generate a channel-state-information matrix based on the preambles. In this embodiment, the channel-state-information matrix (see equation (2)) is an N×2 matrix. The one or more processors 95 generate solutions to the channel-state-information matrix using a mean-square-error algorithm (see equation (4)) to avoid singularities in the solutions. In one implementation of this embodiment, the one or more processors 95 are part of the receiver 106.

The VHF aeronautical network 6 is a single-input-multiple-output (SIMO) system. The downlink data rate in SIMO is increased by a factor of N compared to the currently available systems due to the plurality of ground antennas 180(1−N)). In the uplink, the aeronautical ground station 101 has an option to transmit on one ground antenna, such as ground antenna 180-1 or to transmit on multiple ground antennas 180(1−N) in order to communicate with the aircraft 260-1. When one uplink ground antenna is used, the uplink data rate is the same as the data rate of currently available systems. When N ground antennas are used, the data throughput from aeronautical ground station 101 is increased by up to a factor of N. In one implementation of this embodiment, the ground antennas 180(1−N)) are configured to provide beam shaping, also referred to herein as beam forming, so that the transmitted uplink signal is a spatially shaped signal.

In this manner, the uplink signal is directed to either the first aircraft 260-1 or the second aircraft 260-2.

The computer instructions 120 and/or firmware include a plurality of program instructions (such as, MIMO multi-channel decomposition algorithms) that are stored or otherwise embodied on the storage medium 125 from which at least a portion of such computer instructions are read for execution by the digital signal processors 205(1−N)) and/or the one or more processors 95. In one implementation, the one or more processors 95 and the digital signal processors 205(1−N)) include a microprocessor and/or or microcontroller. In one implementation, the one or more processors 95 and the digital signal processors 205(1−N)) include processor support chips and/or system support chips such as ASICs.

Memory 91 includes any suitable memory now known or later developed such as, for example, random access memory (RAM), read only memory (ROM), and/or registers within the processor 90. Although the one or more processors 95 and the digital signal processors 205(1−N)) are shown as separate elements from the memory 91, in one implementation, each digital signal processor 205(1−N)) and each processor 95 is implemented as single device with a memory (for example, a single integrated-circuit device).

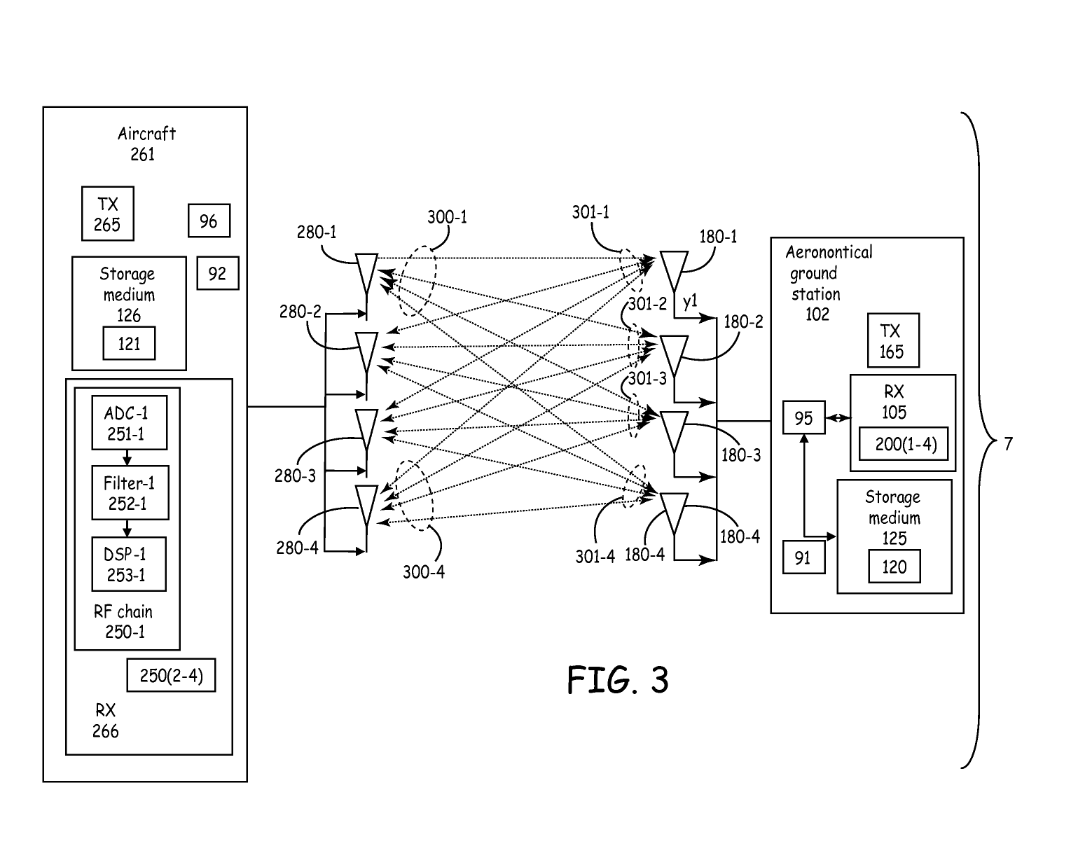

FIG. 3 is a block diagram of one embodiment of a VHF aeronautical network 7 including an aircraft 261 having multiple aircraft antennas 280(1-4) and an aeronautical ground station 102 having multiple ground antennas 180(1-4) in accordance with the present invention. The four aircraft antennas 280(1-4) transmit four respective downlink VHF signals represented generally by numerals 300(1-4) at the same time and at the same carrier frequency. The four ground antennas 180(1-4) transmit four respective uplink VHF signals represented generally at 301(1-4) at the same time and at the same carrier frequency. The four ground antennas 180(1-4) on aeronautical ground station 102 receive VHF signals 300(1-4). The four aircraft antennas 280(1-4) on the aircraft 261 receive the signals 301(1-4). In one implementation of this embodiment, the downlink VHF signals 300(1-4) and the uplink VHF signals 301(1-4) have the same carrier frequency.

The aircraft 261 includes a plurality of aircraft antennas 280(1-4), a transmitter 265, a receiver 266, a memory 92, one or more processors 96, and computer instructions 121 stored on a storage medium 125. The computer instructions 121 are executed by one or more processors 96 and/or digital signal processors 253(1-4) in the receiver 266. In the exemplary case shown in FIG. 3, each antenna 280(1−N)) at the aircraft 261 receives a 4-channel spatially mixed signal. Likewise, each antenna 180(1−N) at the aeronautical ground station 102 receives a 4-channel spatially mixed signal. Channel state information is stored in the memory 92. The channel state information includes information for each radio path within the receiver 266. In one implementation of this embodiment, the channel state information includes attenuation of the signal during propagation and phase-change of the signal during propagation.

The receiver 266 includes four RF chains 250(1-4). The structure and function of the RF chain 250-1 is now described. It is to be understood that the structure and function of the other RF chains 250(2-4) are equivalent to that of the RF chain 250-1. The RF chain 250-1 includes an analog-to-digital converter (ADC) 251-1, a filter 252-1, and a digital signal processor 253-1. The analog-to-digital converter 251-1 receives the 4-channel spatially mixed signal from the communicatively coupled aircraft antenna 280-1 and outputs a converted signal to the filter 210-1. The output from the filter 252-1 is sent to the digital signal processor 253-1. The digital signal processor 253-1 outputs the signal (equivalent to the signal y₁ described above with reference to FIG. 1) to the one or more processors 96. The one or more processors 96 receive signals (equivalent to the signals y₁, y₂, y₃, and y₄ described above with reference to FIG. 1) from the four digital signal processors 253(1-4) in the four RF chains 250(1-4) and execute computer instructions 120 for multiple-input-multiple-output decomposition.

The one or more processors 96 use output from the digital signal processors 253(1-4) to generate a channel-state-information matrix based on the preambles in the uplink signals 301(1-4) and the channel state information. The one or more processors 95 generate solutions to the channel-state-information matrix (see equation (2)) by the mean-square-error algorithm (see equation (4)) to avoid singularities in the solutions. The one or more processors 96 use the solutions of the channel-state-information matrix to decompose the 4-channel spatially mixed signal into the uplink signals 301(1-4). The receiver 266 decodes each of the respective ones of the decomposed uplink signals 301(1-4).

In the exemplary embodiment shown in FIG. 3, the channel-state-information matrix is a 4×4 matrix. In one implementation of this embodiment, the uplink signals 301(1-4) include safety-critical communication navigation signals or safety-critical communication surveillance signals. In another implementation of this embodiment, the uplink signals 301(1-4) include safety-critical signals. In yet another implementation of this embodiment, the uplink signals 301(1-4) include safety-critical communication navigation signals or safety-critical communication surveillance signals and safety-critical signals.

The structure and function of the aeronautical ground station 102 is now described. The aeronautical ground station 102 includes a plurality of ground antennas 180(1-4), a transmitter 165, a receiver 105, a memory 91, one or more processors 96, and computer instructions 120 stored on a storage medium 125 to be executed by the one or more processors 95 and/or digital signal processors 253(1-4) in the receiver 105. The receiver 105 includes four RF chains 200(1-4) that are similar in structure and function to the RF chains 200(1−N)) described above with reference to FIG. 2. The multiple ground antennas 180(1-4) are communicatively coupled to a respective one of the RF chains 200(1-4), which processes the received signals. Channel state information is stored in the memory 91. The channel state information includes information for each radio path within the aeronautical ground station 102.

The four downlink VHF signals 300(1-4) are simultaneously received at the plurality of ground antennas 180(1-4). Thus, the four ground antennas 180(1-4) at the aeronautical ground station 100 each receives a 4-channel spatially mixed signal. The one or more processors 96 implement instructions 120 (such as, MIMO algorithms) to process all four of the received 4-channel spatially mixed signals that are received from the four RF chains 200(1-4). The one or more processors 96 generate a channel-state-information matrix based on the preambles (such as, hᵢⱼ of equation (1)) of the received signals (such as, signals y₁, y₂, y₃, and y₄ of equation (1)) and decompose the 4-channel spatially mixed signals into 4 clear channel signals 300(1-4) based on the solutions to the channel-state-information matrix. The solutions to the channel-state-information matrix are generated by a mean-square-error algorithm to avoid singularities in the solutions generated by directly inversing channel-state-information matrix h. The receiver 105 decodes the signals once the solutions to the channel-state-information matrix are determined.

In one implementation of this embodiment, the transmitter 165 includes beam forming algorithms or computer instructions 120 stored on a storage medium 125 to steer the antenna pattern to direct signals to the aircraft 261. This VHF aeronautical network 7 is a MIMO system. The downlink and uplink data rates in MIMO are increased by a factor of M compared to the currently used SISO system.

In one implementation of this embodiment, the VHF aeronautical network 7 includes a plurality of aircraft 261. In another implementation of this embodiment, the VHF aeronautical network 7 includes at least one aircraft 261 and at least one aircraft 260-1 as shown in FIG. 1.

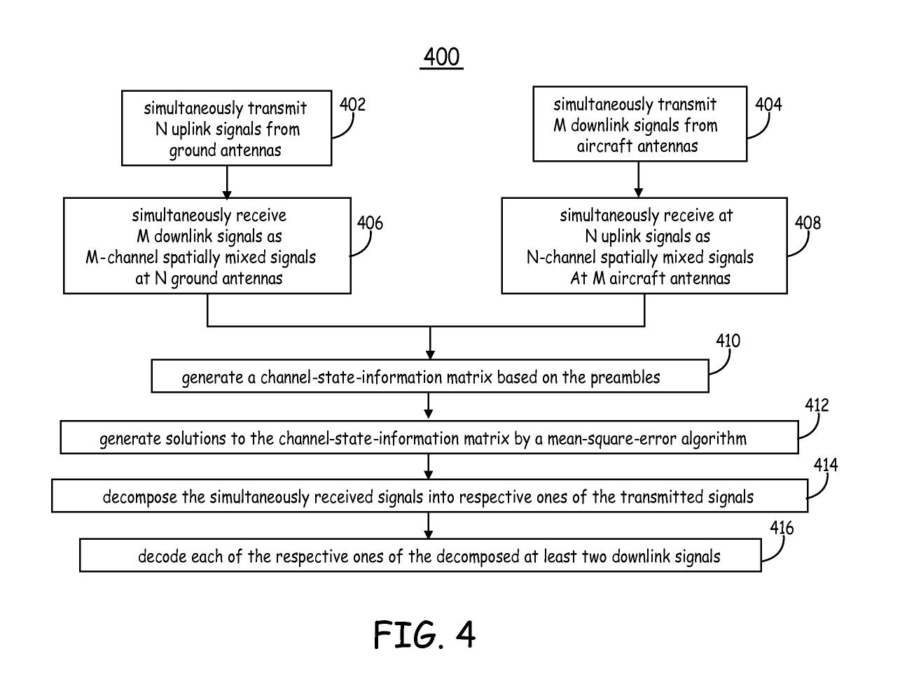

FIG. 4 is a flow diagram of one embodiment of a method 400 to increase throughput of information over a VHF aeronautical network in accordance with the present invention. In this method 400, independent transmission signals from separate and independent sources (such as, separate aircraft) are resolved using multiple-input-multiple-output techniques at a receiver in the aeronautical ground station. In one implementation of this embodiment, the VHF aeronautical network is the VHF aeronautical network 7 as described above with reference to FIG. 3. The method 400 is described with reference to the VHF aeronautical network 7 shown in FIG. 3 although it is to be understood that method 400 can be implemented using other embodiments of the VHF aeronautical network as is understandable by one skilled in the art who reads this document.

At block 402, N uplink signals are simultaneously transmitted from a plurality of ground antennas at aeronautical ground station in the VHF aeronautical network to at least one aircraft. The uplink signals include respective preambles indicative of a channel state. In one implementation of this embodiment, four uplink signals 301(1-4) are simultaneously transmitted from the four ground antennas 108(1-4) at aeronautical ground station 102 in VHF aeronautical network 7 to aircraft 261 having four aircraft antennas 280(1-4).

At block 404, M downlink signals are simultaneously transmitted from M aircraft antennas at an aircraft in the VHF aeronautical network to the aeronautical ground station. The downlink signals include respective preambles indicative of a channel state. In one implementation of this embodiment, four downlink signals are simultaneously transmitted from four aircraft antennas (280(1-4) at the aircraft 261 in the VHF aeronautical network 7 to the aeronautical ground station 102. In another implementation of this embodiment, M downlink signals are simultaneously (or almost simultaneously) transmitted from M aircraft, each aircraft having one aircraft antenna, to the aeronautical ground station in the VHF aeronautical network. In yet another implementation of this embodiment, the steps of blocks 402 and 404 occur at or about the same time.

At block 406, at least two (e.g., M) downlink signals are simultaneously received at a plurality of (e.g., N) ground antennas at an aeronautical ground station of a VHF aeronautical network as M-channel spatially mixed signals. The downlink signals include respective preambles indicative of a channel state. In one implementation of this embodiment, four downlink signals 300(1-4) are simultaneously received at four ground antennas (180(1-4) at the aeronautical ground station 102 of the VHF aeronautical network 7. The step of block 406 occurs responsive to the occurrence of the step at block 404.

At block 408, at least two (e.g., N) uplink signals are simultaneously received at the plurality of (e.g., M) aircraft antennas at the at least one aircraft as N-channel spatially mixed signals. The uplink signals include respective preambles indicative of a channel state. In one implementation of this embodiment, four uplink signals 301(1-4) are simultaneously received at four aircraft antennas 280(1-4) at the aircraft 261. The step of block 408 occurs responsive to the occurrence of the step at block 402. In another implementation of this embodiment, the steps of blocks 406 and 408 occur at or about the same time.

At block 410, a channel-state-information matrix is generated based on preambles. Responsive to the occurrence of the step at block 406 when M downlink signals were received at N ground antennas, the receiver generates an N×M channel-state-information matrix. For example, the receiver 105 in the aeronautical ground station 102 of VHF aeronautical network 7 generates a 4×4 matrix responsive to receiving the four downlink signals 300(1-4) sent from the aircraft 261. The four downlink signals 300(1-4) are received at the four RF chains 200(1-4) in the receiver 105 as four separate 4-channel spatially mixed signals, respectively.

Responsive to the occurrence of the step at block 408 when N uplink signals were received at M aircraft antennas, the receiver generates an M×N channel-state-information matrix. For example, the receiver 266 in the aircraft 261 of VHF aeronautical network 7 generates a 4×4 matrix responsive to receiving the four uplink signals 301(1-4) sent from the aeronautical ground station 102. The four uplink signals 301(1-4) are received at the four RF chains 250(1-4) in the receiver 266 as four separate 4-channel spatially mixed signals, respectively.

At block 412, solutions to the channel-state-information matrix are generated by a mean-square-error algorithm to avoid singularities in the solutions. In one implementation of this embodiment, the receiver 105 in the aeronautical ground station 102 of VHF aeronautical network 7 generates solutions to the 4×4 channel-state-information matrix. In another implementation of this embodiment, the receiver 266 in the aircraft 261 of VHF aeronautical network 7 generates solutions to the 4×4 channel-state-information matrix.

At block 414, the simultaneously received at least two signals are decomposed into respective ones of the at least two downlink signals based on the generated channel-state-information matrix. In one implementation of this embodiment, the simultaneously received downlink signals 300(1-4) are decomposed into four downlink signals 300(1-4), respectively, based on the generated channel-state-information matrix. In another implementation of this embodiment, the simultaneously received uplink signals 301(1-4) are decomposed into four uplink signals 301(1-4), respectively.

At block 416, each of the respective ones of the decomposed at least two signals are decoded. In one implementation of this embodiment, each of the four decomposed downlink signals 300(1-4) are decoded at the receiver 105 in the aeronautical ground station 102. In another implementation of this embodiment, each of the four decomposed uplink signals 301(1-4) are decoded by the receiver 266 in the aircraft 261.

In one implementation of this embodiment, method 400 is implemented for a plurality of aircraft having a plurality of aircraft antennas communicatively coupled to an aeronautical ground station having a plurality of ground antennas. In another implementation of this embodiment, method 400 is implemented for a plurality of aircraft each having a single aircraft antenna communicatively coupled to an aeronautical ground station having a plurality of ground antennas. In yet another implementation of this embodiment, method 400 is implemented for at least one aircraft with a single aircraft antenna and at least one aircraft with a plurality of aircraft antennas all communicatively coupled to an aeronautical ground station having a plurality of ground antennas.

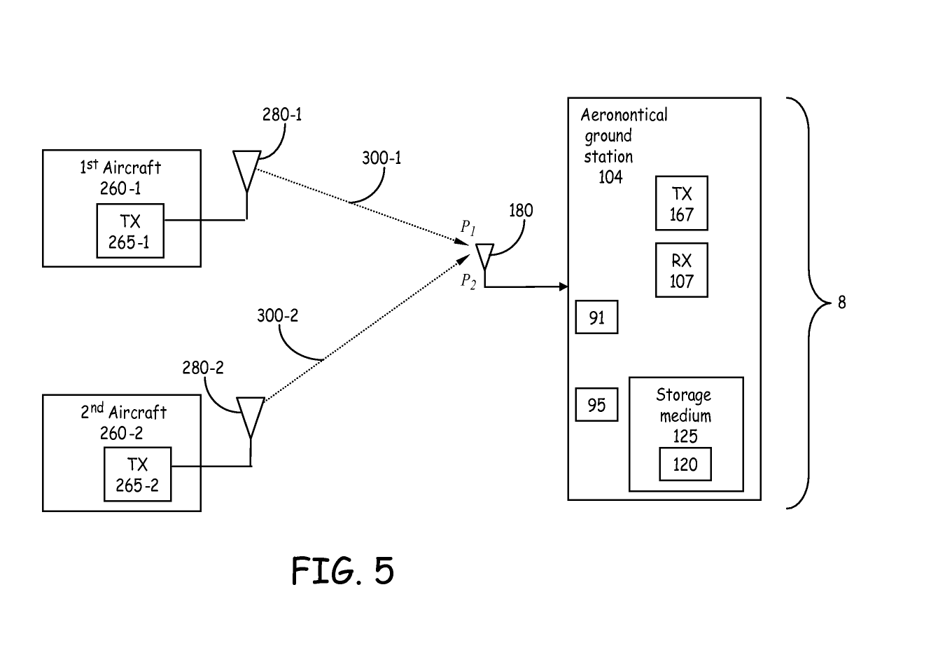

FIG. 5 is a block diagram of one embodiment of a VHF aeronautical network 8 in accordance with the present invention. The VHF aeronautical network 8 includes an aeronautical ground station 104, a first aircraft 260-1, and a second aircraft 260-2. The first aircraft 260-1 and the second aircraft 260-2 are similar in function and structure to the first aircraft 260-1 and the second aircraft 260-2 described above with reference to FIG. 1. The aeronautical ground station 104 includes a single ground antenna 180, a transmitter 167, a receiver 107, one or more processors 95, a memory 91, and computer instructions 120 stored on a storage medium 125 to be executed by one or more processors 95. The transmitter 167 and the receiver 107 are also referred to herein as “VDL radio 167,” and “VDL radio 107,” respectively. The VHF aeronautical network 8 is configured to successively implement the interference cancellation (SIC) algorithms in the aeronautical ground station 104 when two or more colliding signals are received simultaneously at the ground antenna 180.

As shown in FIG. 5, the first aircraft 260-1 and the second aircraft 260-2 simultaneously transmit two data packets in signals represented generally by numerals 300(1-2), respectively, to the aeronautical ground station 104. Specifically, the two aircraft antennas 280(1-2) transmit two respective downlink VHF signals 300-1 and 300-2 at the same time (in the same time slot) and at the same carrier frequency (in the same radio frequency channel). The power level of the signals 300(1-2) received from the first aircraft 260-1 and the second aircraft 260-2 are denoted as p₁ and p₂, respectively. Without loss of generality, it is assumed that p₁>p₂. But by implementing SIC algorithms in the VDL radio 167 it is possible to detect two or more colliding signals simultaneously. The SIC algorithms are based on the type of signal of the received signals 300(1-2), since the minimum required signal-to-noise-and-interference ratio (SNIR) is dependent upon the type of signal. As defined herein, type of signals include data signals, navigation signals, video signals, safety critical signals, and combinations thereof. The receiver 107 recognizes the type of signal based on the protocol of the received signal and/or the format of the received signal. The minimum required SNIR is usually determined by signal modulation and minimum required bit error rate. For example, for BPSK signals that require a bit error rate to be lower than 10⁻⁵, the minimum required signal-to-noise-and-interference ratio is 9.6 dB. For other type of signals and bit error rate requirements, the minimum required signal-to-noise-and-interference ratio is different.

When the received SNIR is greater than the minimum required SNIR, i.e.,

$$\frac{{p}_{1}}{{p}_{2} + {N}_{0}} > {SNR}_{min} ,$$

signal p₁ is decoded. Then signal p₁ is removed from the received signal. If

$$\frac{{p}_{2}}{{N}_{0}} > {SNR}_{min} ,$$

then signal p₂ is decoded. This procedure is repeated until all collided signals are decoded. The SIC does not require changes in the current VDL radio hardware. A software update to install the SIC algorithms in the aeronautical ground station 104 is required to increase the current VDL down link throughput. To determine p1 or p2, the software calculates the real power of p1 or p2 by multiplying the digital sample power with the gain of the RF chain.

In one implementation of the VHF aeronautical network 8, the actual power levels p1 or p2 are not known. In this embodiment, the first signal is decoded and the processor 95 checks that the signal is correctly decoded with cyclic redundancy check (CRC). If CRC is correct, the first signal is correctly decoded and the process continues for the second signal. If the CRC is correct, the SNIR is greater than the minimum required SNIR for the type of signal. If the CRC is not correct, the SNIR for the first signal is too low and the process is terminated. In this manner, the process continues until the signal is less than the minimum required SNIR for the type of signal.

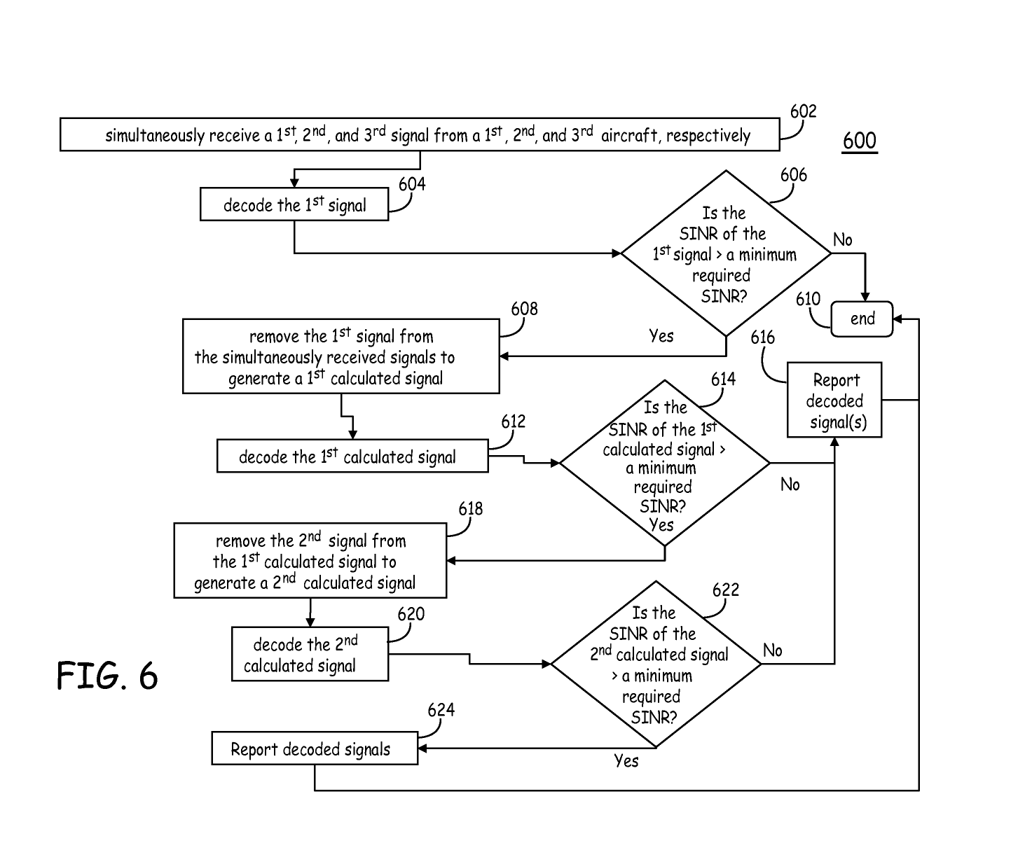

The method of implementing this latter embodiment is shown in FIG. 6. FIG. 6 is a flow diagram 600 of one embodiment of a method to increase throughput of information over a VHF aeronautical network in accordance with the present invention. In one implementation of this embodiment, the VHF aeronautical network is the VHF aeronautical network 8 as described above with reference to FIG. 6. The method 600 is described with reference to the VHF aeronautical network 8 shown in FIG. 6 with a third aircraft that sends a third signal although it is to be understood that method 600 can be implemented using other embodiments of the VHF aeronautical network as is understandable by one skilled in the art who reads this document.

At block 602, the aeronautical ground station simultaneously receives a first signal from a first aircraft, a second signal from a second aircraft, and a third signal from a third aircraft. The power amplitude p1 of the first signal is greater than the power amplitude p2 of the second signal, which is greater than the power amplitude p3 of the third signal. The first signal is a first type of signal, the second signal is a second type of signal, and the third signal is a third type of signal. In one implementation of this embodiment, the first and the second signal are the same type. In another implementation of this embodiment, the second and the third signal are the same type. In yet another implementation of this embodiment, the first and the third signal are the same type. In yet another implementation of this embodiment, the first, second and third signals are the same type. In yet another implementation of this embodiment, the aeronautical ground station 104 simultaneously receives a first signal from a first aircraft 260-1, a second signal from a second aircraft 261-2 (FIG. 5), and a third signal from a third aircraft (not shown in FIG. 5).

At block 604, the receiver 107 decodes the first signal. The second and the third signals are treated as noise for the first signal. At block 606, the receiver 107 determines if the SNIR of the first signal is greater than a minimum required SNIR, i.e., SNRₘᵢₙ₁, for the first type of signal. The receiver 107 checks to see if the CRC is correct. If it is correct, the SNIR of the first signal is greater than a minimum required SNIR for the first type of signal.

In another implementation of this embodiment, the step of block 606 occurs before the step at block 604. In this case, the receiver 107 determines the actual power level p1 and then determines if p1(p2+p3+N0)>SNRₘᵢₙ₁, where N0 is noise. If p1(p2+p3+N0)>SNRₘᵢₙ₁ is true, then the first signal is decoded to generate the second signal.

If the SNIR of the first signal is less than the minimum required SNIR of the first signal, the flow proceeds to block 610 and the flow is terminated. If the SNIR of the first signal is greater than the minimum required SNIR of the first signal, the flow proceeds to block 608.

At block 608, the first signal is removed from the simultaneously received signals to generate a calculated signal, also referred to herein as a first calculated signal.

At block 612, the receiver 107 decodes the first calculated signal. The third signal is treated as noise for the first calculated signal. At block 614, the receiver 107 determines if the SNIR for the first calculated signal is greater than a minimum required SNIR, i.e., SNRₘᵢₙ₂, for the second type of signal. The receiver 107 checks to see if the CRC is correct. If it is correct, the SNIR of the first signal is greater than a minimum required SNIR for the second type of signal.

In another implementation of this embodiment, the step of block 614 occurs before the step at block 612. In this case, the receiver 107 determines the actual power level p2 and then determines if p2(p3+n0)>SNR ₘᵢₙ₂. If p2(p3+n0)>SNRₘᵢₙ₂ is true, then the first calculated signal is decoded to generate the second signal.

If the SNIR of the first calculated signal is less than the minimum required SNIR of the first signal, the flow proceeds to block 616. At block 616, the decoded first signal is reported and the flow proceeds to block 610. At block 610 the flow is terminated. If the SNIR of the first calculated signal is greater than the minimum required SNIR of the second signal, the flow proceeds to block 618. At block 618, the second signal is removed from the first calculated signal to generate a second calculated signal.

At block 620, the receiver 107 decodes the second calculated signal. At block 622, the receiver 107 determines if the SNIR for the second calculated signal is greater than a minimum required SNIR, i.e., SNRₘᵢₙ₃, for the third type of signal. The receiver 107 checks to see if the CRC is correct. If the CRC is correct, the SNIR of the third signal is greater than a minimum required SNIR for the third type of signal.

In another implementation of this embodiment, the step of block 622 occurs before the step at block 620. In this case, the receiver 107 determines the actual power level p3 and then determines if and p3/n0>SNRₘᵢₙ₃. If and p3/n0>SNRₘᵢₙ₃ is true, then the second calculated signal is decoded to generate the third signal.

If the SNIR of the second calculated signal is less than the minimum required SNIR of the third signal, the flow proceeds to block 616. At block 616, the decoded first and second signals are reported and the flow proceeds to block 610. At block 610 the flow is terminated. If the SNIR of the second calculated signal is greater than the minimum required SNIR of the third signal, the flow proceeds to block 624. At block 624, the decoded messages are reported.

It is to be understood that method 600 is not limited to three signals but can be extended to N-signals. The method 600 can be implemented to decode N-signals received at an aeronautical ground station from N aircraft that have each sent a signal to the aeronautical ground station.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A method to increase throughput of information over a very high frequency aeronautical network, the method comprising:
simultaneously receiving at least two downlink signals at a plurality of ground antennas at an aeronautical ground station of the very high frequency aeronautical network, the at least two downlink signals including respective preambles indicative of a channel state;
generating a channel-state-information matrix based on the preambles, wherein solutions to the channel-state-information matrix are generated by a mean-square-error algorithm to avoid singularities in the solutions;
decomposing the simultaneously received at least two downlink signals into respective ones of the at least two downlink signals based on the generated channel-state-information matrix; and
decoding each of the respective ones of the decomposed at least two downlink signals, wherein independent transmissions from separate and independent sources are resolved using multiple-input-multiple-output techniques at a receiver in the aeronautical ground station.

2. The method of claim 1, wherein the downlink signals include one of safety-critical communication navigation signals and safety-critical communication surveillance signals.

3. The method of claim 1, further comprising:
transmitting signals from the plurality of ground antennas to at least one aircraft.

4. The method of claim 3, wherein the at least one aircraft includes a plurality of aircraft antennas, and wherein the method further comprises:
simultaneously receiving at least two uplink signals from a single ground station at the plurality of aircraft antennas at the at least one aircraft, the uplink signals including respective preambles indicative of a channel state;
generating a channel-state-information matrix based on the preambles, wherein solutions to the channel-state-information matrix are generated by a mean-square-error algorithm to avoid singularities in the solutions; and
decomposing the simultaneously received at least two uplink signals into respective ones of the at least two uplink signals at a software defined radio system.

5. The method of claim 4, further comprising decoding each of the respective ones of the decomposed at least two uplink signals.

6. The method of claim 4, wherein each of the at least one aircraft comprises:
a plurality of RF chains, each RF chain associated with a respective one of the plurality of aircraft antennas, and each RF chain including,
a filter, and
a digital signal processor to receive output from the filter, the digital signal processor operable to execute computer instructions for multiple-input-multiple-output decomposition.

7. The method of claim 1, wherein the aeronautical ground station comprises:
a plurality of RF chains, each RF chain associated with a respective one of the plurality of ground antennas, and each RF chain including,
a filter, and
a digital signal processor to receive output from the filter, the digital signal processor operable to execute computer instructions for multiple-input-multiple-output decomposition and operable to execute computer instructions for beamforming.

8. The method of claim 7, further comprising:
transmitting spatially shaped signals from the plurality of ground antennas to at least two aircraft, wherein the spatially shaped signals are shaped based on the computer instructions for beamforming.

9. The method of claim 1, further comprising:
transmitting spatially shaped signals from the plurality of ground antennas to at least two aircraft, wherein the spatially shaped signals are shaped based on computer instructions for beamforming.

10-14. (canceled)

15. A non-transitory computer readable medium encoded with computer instructions stored thereon for a method to increase throughput of information over a very high frequency aeronautical network, the computer readable medium comprising:
generating a channel-state-information matrix based on preambles of at least two simultaneously received signals, the preambles indicative of a channel state for the at least two simultaneously received signals;
decomposing the simultaneously received at least two signals into respective ones of the at least two signals based on the generated channel-state-information matrix; and
decoding each of the respective ones of the decomposed at least two signals.

16. The non-transitory computer readable medium of claim 15, wherein the readable medium encoded with computer instructions for generating a channel-state-information matrix comprises:
computer readable medium encoded with a mean-square-error algorithm, wherein singularities in the solution are avoided.

17. The non-transitory computer readable medium of claim 15, wherein the readable medium encoded with computer instructions for decomposing the simultaneously received at least two signals comprises computer readable medium encoded with a multiple-input-multiple-output decomposing algorithm.

18-19. (canceled)
